(19) United States
(12) Patent Application Publication
(10) Pub. No.: US 2011/0068702 A1
(43) Pub. Date: Mar. 24, 2011

(54) SOLID STATE LIGHTING APPARATUS WITH CONTROLLABLE BYPASS CIRCUITS AND METHODS OF OPERATION THEREOF

(75) Inventors: Antony P. van de Ven, Sai Kung (HK); Gerald H. Negley, Chapel Hill, NC (US); Paul Kenneth Pickard, Morrisville, NC (US); Joseph Paul Chobot, Morrisville, NC (US); Michael James Harris, Cary, NC (US); Terry Given, Papakura (NZ)

(73) Assignee: Cree LED Lighting Solutions, Inc.

(21) Appl. No.: 12/566,195

(22) Filed: Sep. 24, 2009

(51) Int. Cl. H05B 37/00; H05B 39/00

(52) U.S. Cl. 315/186; 315/185 R

(57) ABSTRACT

A lighting apparatus includes a string with a plurality of serially-connected light emitting device sets, each set comprising at least one light emitting device. The apparatus further includes at least one controllable bypass circuit configured to variably bypass current around at least one light emitting device of a set of the plurality of light emitting device sets responsive to a control input. The control input may include, for example, a temperature input, a string current sense input and/or an adjustment input. The control input may be varied, for example, to adjust a color point of the string.

### FIELD

The present inventive subject matter relates to lighting apparatus and, more particularly, to solid state lighting apparatus.

### BACKGROUND

Solid state lighting devices are used for a number of lighting applications. For example, solid state lighting panels including arrays of solid state light emitting devices have been used as direct illumination sources, for example, in architectural and/or accent lighting. A solid state light emitting device may include, for example, a packaged light emitting device including one or more light emitting diodes (LEDs). Inorganic LEDs typically include semiconductor layers forming p-n junctions. Organic LEDs (OLEDs), which include organic light emission layers, are another type of solid state light emitting device. Typically, a solid state light emitting device generates light through the recombination of electronic carriers, i.e. electrons and holes, in a light emitting layer or region.

The color rendering index (CRI) of a light source is an objective measure of the ability of the light generated by the source to accurately illuminate a broad range of colors. The color rendering index ranges from essentially zero for monochromatic sources to nearly 100 for incandescent sources. Light generated from a phosphor-based solid state light source may have a relatively low color rendering index.

It is often desirable to provide a lighting source that generates a white light having a high color rendering index, so that objects and/or display screens illuminated by the lighting panel may appear more natural. Accordingly, to improve CRI, red light may be added to the white light, for example, by adding red emitting phosphor and/or red emitting devices to the apparatus. Other lighting sources may include red, green and blue light emitting devices. When red, green and blue light emitting devices are energized simultaneously, the resulting combined light may appear white, or nearly white, depending on the relative intensities of the red, green and blue sources.

### SUMMARY

A lighting apparatus according to some embodiments of the present inventive subject matter includes a string with a plurality of serially-connected light emitting device sets, each set comprising at least one light emitting device. The apparatus further includes at least one controllable bypass circuit configured to variably bypass current around at least one light emitting device of a set of the plurality of light emitting device sets responsive to a control input. The control input may include, for example, a temperature input, a string current sense input, a light input and/or an adjustment input.

In some embodiments, the plurality of light emitting device sets includes a plurality of color point sets. The plurality of color point sets may include, for example, a set of nominally blue-shifted yellow (BSY) light emitting diodes (LEDs) and a set of nominally red LEDs, and the controllable bypass circuit may be configured to variably bypass current around at least one LED of the set of nominally BSY LEDs.

In further embodiments of the present inventive subject matter, the at least one controllable bypass circuit comprises a plurality of controllable bypass circuits, respective ones of which are configured to variably bypass respective currents around at least one light emitting device of respective ones of the plurality of light emitting device sets. In some embodiments, the at least one controllable bypass circuit may include a plurality of controllable bypass circuit connected in parallel with the at least one light emitting device and configured to variably bypass current around the at least one light emitting device responsive to respective control inputs.

According to some embodiments, the controllable bypass circuit may include a variable resistance circuit, such as a transistor biased by a voltage divider. In further embodiments, the controllable bypass circuit may include a switch configured to couple and decouple circuit nodes connected to the at least one light emitting device and a PWM controller circuit configured to operate the switch responsive to the control input.

According to further aspects of the present invention, the at least one controllable bypass circuit may be configured to be powered via at least one node of the string. For example, the at least one controllable bypass circuit may be configured to be powered by a forward voltage across at least one light-emitting device in the string.

In additional embodiments, the at least one controllable bypass circuit may include a communications circuit configured to receive the control input via the string.

Further embodiments of the present inventive subject matter provide a lighting apparatus including a string comprising at least one LED and at least one controllable bypass circuit configured to variably bypass current around at the at least one LED via at least one ancillary diode having a different forward voltage characteristic than the at least one LED responsive to a control input. The control input may include, for example, a temperature input, a string current sense input and/or an adjustment input. The at least one ancillary diode may include, for example, at least one ancillary LED, such as an ancillary LED having a different color point than the at least one LED. In other embodiments, the at least one ancillary diode may be configured to emit non-visible electromagnetic radiation.

In some embodiments, the at least one controllable bypass circuit comprises a switch connected in series with the ancillary diode and configured to couple and decouple circuit nodes connected to the at least one LED and a PWM controller circuit configured to operate the switch responsive to the control input. In further embodiments, the at least one controllable bypass circuit may include a variable resistance circuit.

According to further aspects, the at least one controllable bypass circuit may be configured to be powered via at least one node of the string. The at least one controllable bypass circuit may be configured to be powered by a forward voltage across the at least one ancillary diode.

In some embodiments, the at least one controllable bypass circuit may include a plurality of controllable bypass circuits, respective ones of which are configured to variably bypass respective currents around respective at least one LEDs. In further embodiments, the at least one controllable bypass circuit may include a plurality of controllable bypass circuit connected in parallel with the at least one LED and configured to variably bypass current around the at least one LED responsive to respective control inputs.

Further embodiments of the present invention provide methods of adjusting a lighting apparatus including a string having a plurality of serially-connected light emitting device sets, each set including at least one light emitting device. The methods include bypassing current around at least one light emitting device of a set of the plurality of light emitting device sets responsive to a control input. The control input may be varied, for example, to adjust a color point of the string.

The plurality of light emitting device sets may include, for example, a plurality of color point sets, such as a set of nominally blue-shifted yellow (BSY) light emitting diodes (LEDs) and a set of nominally red LEDs. Bypassing current around at least one light emitting device of a set of the plurality of light emitting device sets responsive to a control input may include bypassing current around at least one LED of the set of nominally BSY LEDs.

Bypassing current around at least one light emitting device of a set of the plurality of light emitting device sets responsive to a control input may include bypassing respective currents around at least one light emitting device of respective ones of the plurality of light emitting device sets. Bypassing current around at least one light emitting device of a set of the plurality of light emitting device sets responsive to a control input may include bypassing current around the at least one light emitting device via respective bypass paths responsive to respective control inputs.

Bypassing current around at least one light emitting device of a set of the plurality of light emitting device sets responsive to a control input may include controlling a switch and/or a variable resistance circuit connected in parallel with the at least one light emitting device. Controlling a switch and/or a variable resistance circuit connected in parallel with the at least one light emitting device may include controlling the switch and/or the variable resistance circuit responsive to a temperature, a string current and/or an external input.

Further embodiments of the present invention provide methods of operating a lighting apparatus including a string with at least one LED. The methods include bypassing current around at the at least one LED via at least one ancillary diode having a different forward voltage characteristic than the at least one LED responsive to a control input. The control input may include a temperature input, a string current sense input and/or an adjustment input. The control input may be varied, for example, to adjust a color point of the string. The at least one ancillary diode may include at least one ancillary LED, such as an LED having a different color point. Bypassing current around the at least one LED via at least one ancillary diode having a different forward voltage characteristic than the at least one LED responsive to a control input may include conducting current through the ancillary diode using a switch and/or a variable resistance circuit.

A lighting apparatus according to further embodiments of the present inventive subject matter includes a string comprising a plurality of serially-connected light emitting device sets, each set comprising at least one light emitting device and a fixed bypass circuit configured to bypass a fixed amount of current around at least one light emitting device of at least one selected set of the plurality of light emitting device sets over a range of levels of a total current passing through the string. The fixed bypass circuit may be configured to bypass at least one light emitting device of a first set of the plurality of light emitting device sets such that, in response to variation of the total current, a current passing through the first set varies at a different rate than a current passing through a second set of the plurality of light emitting device sets. The apparatus may further include a controllable bypass circuit configured to variably bypass current around at least one light emitting device of the second set of light emitting devices responsive to a control input.

Other apparatus and/or methods according to embodiments of the present inventive subject matter will be or become apparent to one with skill in the art upon review of the following drawings and detailed description. It is intended that all such additional apparatus and/or methods be included within this description, be within the scope of the present inventive subject matter, and be protected by the accompanying claims.

### BRIEF DESCRIPTION OF THE DRAWINGS

The accompanying drawings, which are included to provide a further understanding of the present inventive subject matter and are incorporated in and constitute a part of this application, illustrate certain embodiment(s) of the present inventive subject matter.

FIGS. 1A and 1B illustrate a solid state lighting apparatus in accordance with some embodiments of the present inventive subject matter.

FIG. 2 illustrates a lighting apparatus with a controllable bypass circuit according to some embodiments of the present inventive subject matter.

FIGS. 3 and 4 illustrate lighting apparatus with multiple controllable bypass circuits according to some embodiments of the present inventive subject matter.

FIG. 5 illustrates a lighting apparatus with a controllable bypass circuit and multiple string configurations according to some embodiments of the present inventive subject matter.

FIG. 6 illustrates interconnections of a lighting apparatus with a controllable bypass circuit according to some embodiments of the present inventive subject matter.

FIGS. 7 and 8 illustrate lighting apparatus with controllable bypass circuits for selected color point sets according to some embodiments of the present inventive subject matter.

FIG. 9 illustrates a lighting apparatus with a variable resistance bypass circuit according to some embodiments of the present inventive subject matter.

FIGS. 10 and 11 illustrate lighting apparatus with a pulse width modulated bypass circuits according to some embodiments of the present inventive subject matter.

FIG. 12 illustrates a lighting apparatus with a pulse width modulated bypass circuit with an ancillary diode according to some embodiments of the present inventive subject matter.

FIG. 13 illustrates a lighting apparatus with a string-powered pulse width modulated bypass circuit with an ancillary diode according to some embodiments of the present inventive subject matter.

FIG. 14 illustrates a lighting apparatus with a current-sensing pulse width modulated bypass circuit according to some embodiments of the present inventive subject matter.

FIG. 15 illustrates a lighting apparatus with multiple pulse width modulated bypass circuits according to some embodiments of the present inventive subject matter.

FIG. 16 illustrates a lighting apparatus with parallel pulse width modulated bypass circuits according to some embodiments of the present inventive subject matter.

FIG. 17 illustrates a multi-input PWM control circuit for a lighting apparatus with a pulse width modulated bypass circuit according to some embodiments of the present inventive subject matter.

FIG. 18 illustrates a lighting apparatus including a PWM controller circuit with communications capability according to further embodiments of the present inventive subject matter.

FIG. 19 illustrates a lighting apparatus including one or more controllable bypass circuits that operate responsive to a colorimeter according to further embodiments of the present inventive subject matter.

FIG. 20 illustrates operations for controlling bypass currents to produce a desired light color according to further embodiments of the present inventive subject matter.

FIG. 21 illustrates a lighting apparatus with fixed bypass circuitry and controllable bypass circuitry according to some embodiments of the present inventive subject matter.

### DETAILED DESCRIPTION OF EMBODIMENTS

Embodiments of the present inventive subject matter now will be described more fully hereinafter with reference to the accompanying drawings, in which embodiments of the present inventive subject matter are shown. This present inventive subject matter may, however, be embodied in many different forms and should not be construed as limited to the embodiments set forth herein. Rather, these embodiments are provided so that this disclosure will be thorough and complete, and will fully convey the scope of the present inventive subject matter to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present inventive subject matter. As used herein, the term “and/or” includes any and all combinations of one or more of the associated listed items.

It will be understood that when an element such as a layer, region or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the present inventive subject matter. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present inventive subject matter belongs. It will be further understood that terms used herein should be interpreted as having a meaning that is consistent with their meaning in the context of this specification and the relevant art and will not be interpreted in an idealized or overly formal sense unless expressly so defined herein. The term “plurality” is used herein to refer to two or more of the referenced item.

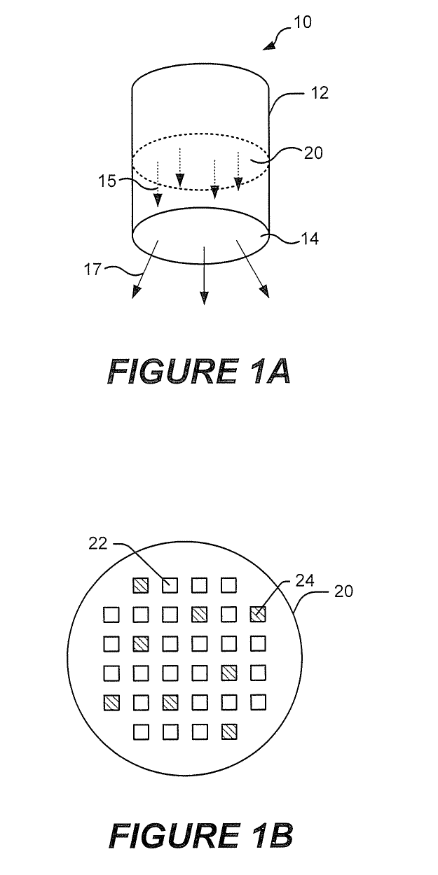

Referring to FIGS. 1A and 1B, a lighting apparatus 10 according to some embodiments is illustrated. The lighting apparatus 10 shown in FIGS. 1A and 1B is a “can” lighting fixture that may be suitable for use in general illumination applications as a down light or spot light. However, it will be appreciated that a lighting apparatus according to some embodiments may have a different form factor. For example, a lighting apparatus according to some embodiments can have the shape of a conventional light bulb, a pan or tray light, an automotive headlamp, or any other suitable form.

The lighting apparatus 10 generally includes a can shaped outer housing 12 in which a lighting panel 20 is arranged. In the embodiments illustrated in FIGS. 1A and 1B, the lighting panel 20 has a generally circular shape so as to fit within an interior of the cylindrical housing 12. Light is generated by solid state lighting devices (LEDs) 22, 24, which are mounted on the lighting panel 20, and which are arranged to emit light 15 towards a diffusing lens 14 mounted at the end of the housing 12. Diffused light 17 is emitted through the lens 14. In some embodiments, the lens 14 may not diffuse the emitted light 15, but may redirect and/or focus the emitted light 15 in a desired near-field or far-field pattern.

Still referring to FIGS. 1A and 1B, the solid-state lighting apparatus 10 may include a plurality of first LEDs 22 and a plurality of second LEDs 24. In some embodiments, the plurality of first LEDs 22 may include white emitting, or near white emitting, light emitting devices. The plurality of second LEDs 24 may include light emitting devices that emit light having a different dominant wavelength from the first LEDs 22, so that combined light emitted by the first LEDs 22 and the second LEDs 24 may have a desired color and/or spectral content. For example, the combined light emitted by the plurality of first LEDs 22 and the plurality of second LEDs 24 may be warm white light that has a high color rendering Index.

The chromaticity of a particular light source may be referred to as the “color point” of the source. For a white light source, the chromaticity may be referred to as the “white point” of the source. The white point of a white light source may fall along a locus of chromaticity points corresponding to the color of light emitted by a black-body radiator heated to a given temperature. Accordingly, a white point may be identified by a correlated color temperature (CCT) of the light source, which is the temperature at which the heated black-body radiator matches the hue of the light source. White light typically has a CCT of between about 2500K and 8000K. White light with a CCT of 2500K has a reddish color, white light with a CCT of 4000K has a yellowish color, and while light with a CCT of 8000K is bluish in color.

“Warm white” generally refers to white light that has a CCT between about 3000 and 3500° K. In particular, warm white light may have wavelength components in the red region of the spectrum, and may appear yellowish to an observer. Incandescent lamps are typically warm white light. Therefore, a solid state lighting device that provides warm white light can cause illuminated objects to have a more natural color. For illumination applications, it is therefore desirable to provide a warm white light. As used herein, white light refers to light having a color point that is within 7 MacAdam step ellipses of the black body locus or otherwise falls within the ANSI C78-377 standard.

In order to achieve warm white emission, conventional packaged LEDs include either a single component orange phosphor in combination with a blue LED or a mixture of yellow/green and orange/red phosphors in combination with a blue LED. However, using a single component orange phosphor can result in a low CRT as a result of the absence of greenish and reddish hues. On the other hand, red phosphors are typically much less efficient than yellow phosphors. Therefore, the addition of red phosphor in yellow phosphor can reduce the efficiency of the package, which can result in poor luminous efficacy. Luminous efficacy is a measure of the proportion of the energy supplied to a lamp that is converted into light energy. It is calculated by dividing the lamp's luminous flux, measured in lumens, by the power consumption, measured in watts.

Warm white light can also be generated by combining non-white light with red light as described in U.S. Pat. No. 7,213,940, entitled “LIGHTING DEVICE AND LIGHTING METHOD,” which is assigned to the assignee of the present inventive subject matter, and the disclosure of which is incorporated herein by reference. As described therein, a lighting device may include first and second groups of solid state light emitters, which emit light having dominant wavelength in ranges of from 430 nm to 480 nm and from 600 nm to 630 nm, respectively, and a first group of phosphors which emit light having dominant wavelength in the range of from 555 nm to 585 nm. A combination of light exiting the lighting device which was emitted by the first group of emitters, and light exiting the lighting device which was emitted by the first group of phosphors produces a sub-mixture of light having x, y color coordinates within a defined area on a 1931 CIE Chromaticity Diagram that is referred to herein as “blue-shifted yellow” or “BSY.” Such non-white light may, when combined with light having a dominant wavelength from 600 nm to 630 nm, produce warm white light.

Blue and/or green LEDs used in a lighting apparatus according to some embodiments may be InGaN-based blue and/or green LED chips available from Cree, Inc., the assignee of the present inventive subject matter. Red LEDs used in the lighting apparatus may be, for example, AlInGaP LED chips available from Epistar, Osram and others.

In some embodiments, the LEDs 22, 24 may have a square or rectangular periphery with an edge length of about 900 μm or greater (i.e. so-called “power chips.” However, in other embodiments, the LED chips 22, 24 may have an edge length of 500 μm or less (i.e. so-called “small chips”). In particular, small LED chips may operate with better electrical conversion efficiency than power chips. For example, green LED chips with a maximum edge dimension less than 500 microns and as small as 260 microns, commonly have a higher electrical conversion efficiency than 900 micron chips, and are known to typically produce 55 lumens of luminous flux per Watt of dissipated electrical power and as much as 90 lumens of luminous flux per Watt of dissipated electrical power.

The LEDs 22 in the lighting apparatus 10 may include white/BSY emitting LEDs, while the LEDs 24 in the lighting apparatus may emit red light. Alternatively or additionally, the LEDs 22 may be from one color bin of white LEDs and the LEDs 24 may be from a different color bin of white LEDs. The LEDs 22, 24 in the lighting apparatus 10 may be electrically interconnected in one or more series strings, as in embodiments of the present inventive subject matter described below. While two different types of LEDs are illustrated, other numbers of different types of LEDs may also be utilized. For example, red, green and blue (RGB) LEDs, RGB and cyan, RGB and white, or other combinations may be utilized.

To simplify driver design and improve efficiency, it is useful to implement a single current source for powering a series-connected string of LEDs. This may present a color control problem, as every emitter in the string typically receives the same amount of current. It is possible to achieve a desired color point by hand picking a combination of LEDs that comes close enough when driven with a given current. If either the current through the string or the temperature of the LEDs changes, however, the color may change as well.

Some embodiments of the present inventive subject matter arise from a realization that color point control of the combined light output of LEDs that are configured in a single string may be achieved by selectively bypassing current around certain LEDs in a string having at least two LEDs having different color points. As used herein, LEDs have different color points if they come from different color, peak wavelength and/or dominant wavelength bins. The LEDs may be LEDs, phosphor converted LEDs or combinations thereof. LEDs are configured in a single string if the current through the LEDs cannot be changed without affecting the current through other LEDs in the string. In other words, the flow of current through any given branch of the string may be controlled but the total quantity of current flowing through the string is established for the entire string. Thus, a single string of LEDs may include LEDs that are configured in series, in parallel and/or in series/parallel arrangements.

In some embodiments, color point control may be provided in a single string by selectively bypassing current around portions of the string to control current through selected portions of the string. In some embodiments, a bypass circuit pulls current away from a portion of the string to reduce the light output level of that portion of the string. The bypass circuit may also supply current to other portions of the string, thus causing some portions of the string to have current reduced and other portions of the string to have current increased. LEDs may be included in the bypass path. In some embodiments, a bypass circuit shunting circuit may switch current between two or more paths in the string. The control circuitry may be biased or powered by the voltage across the string or a portion of the string and, therefore, may provide self contained, color tuned LED devices.

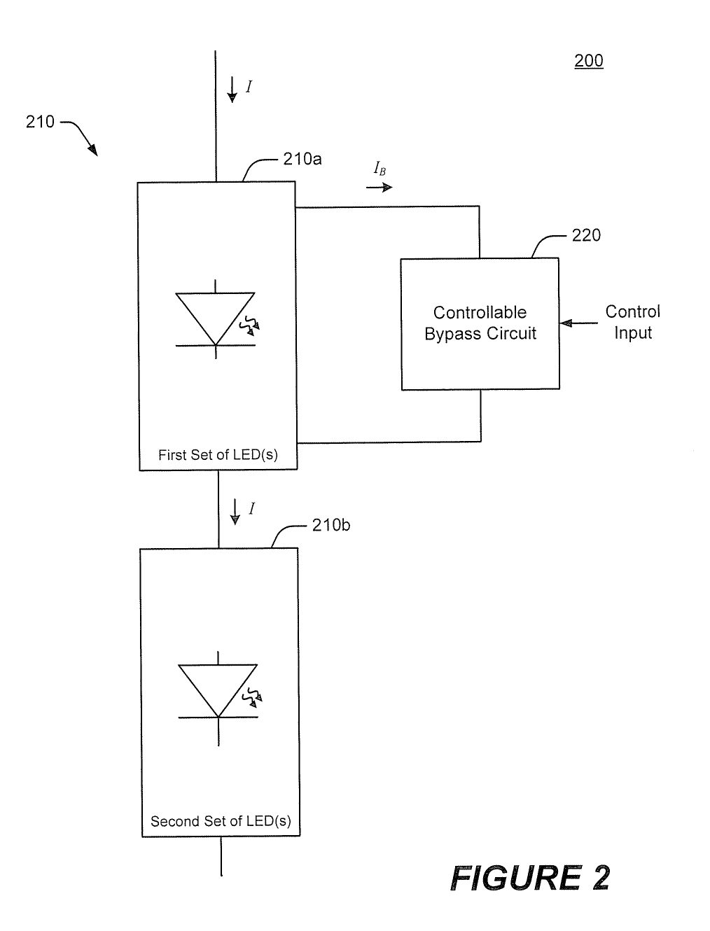

FIG. 2 illustrates a lighting apparatus 200 according to some embodiments of the present inventive subject matter. The apparatus includes a string of series connected light-emitting devices, specifically a string 210 including first and second sets 210a, 210b, each including at least one light emitting diode (LED). In the illustrated embodiments, the apparatus includes a controllable bypass circuit 220 configured to selectively bypass a current I_{B} around the first set 210a responsive to a control input, such that an amount of illumination provided by the first set 210a of the first type may be controlled relative to the illumination provided by the at least one LED 210b of the second type. The control input may include, for example, a temperature, a string current, a light input (e.g., a measurement of light output and/or ambient light) and/or a user adjustment.

The first and second sets may be defined according to a variety of different criteria. For example, in some embodiments described below, a controllable bypass circuit along the lines of the bypass circuit 220 of FIG. 1 may be used to control illumination provided by different color point sets of LEDs in a serial string. In other embodiments, LED sets may be defined according to other characteristics, such as current vs. illumination characteristics.

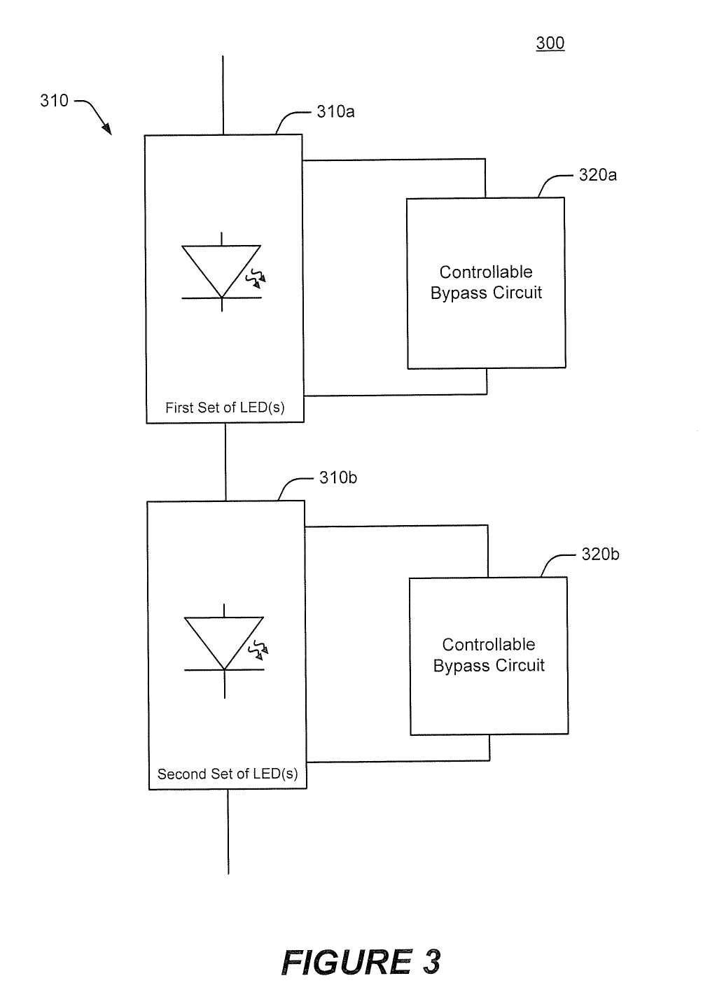

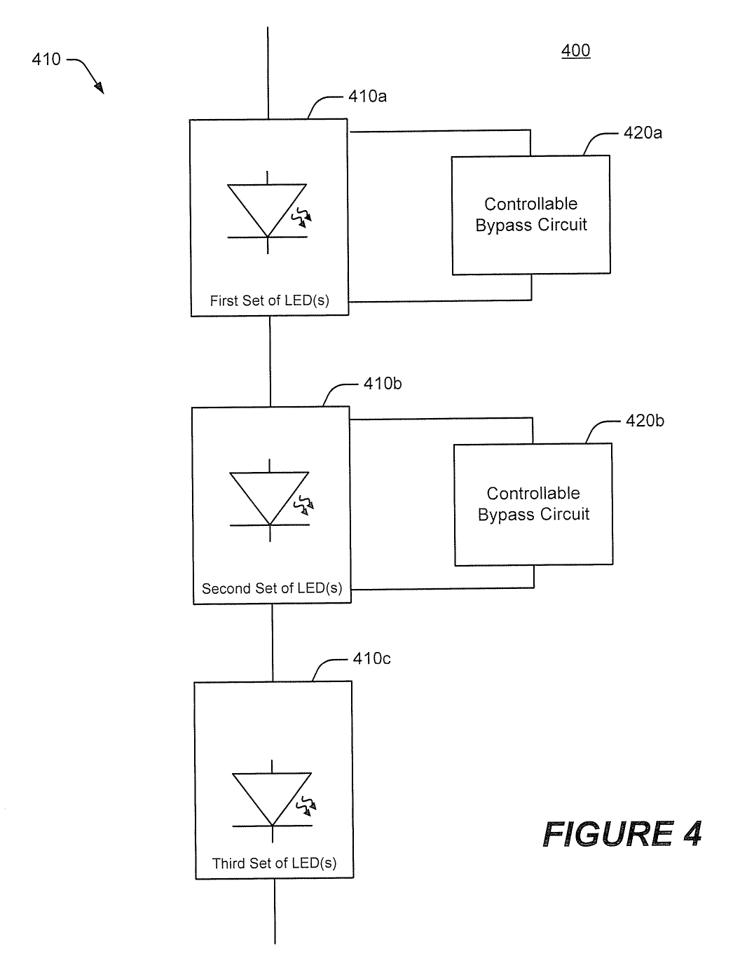

In some embodiments, multiple such controllable bypass circuits may be employed for multiple sets. For example, as illustrated in FIG. 3, a lighting apparatus 300 according to some embodiments of the present inventive subject matter may include a string 310 comprising first and second sets of LEDs 310a, 310b. Respective controllable bypass circuits 320a, 320b are provided for the respective sets of LEDs. As illustrated in FIG. 4, a lighting apparatus 400 may include a string 410 with three sets 410a, 410a, 410c of LEDs, wherein only the first and second sets 410a, 410b have associated controllable bypass circuits 420a, 420b.

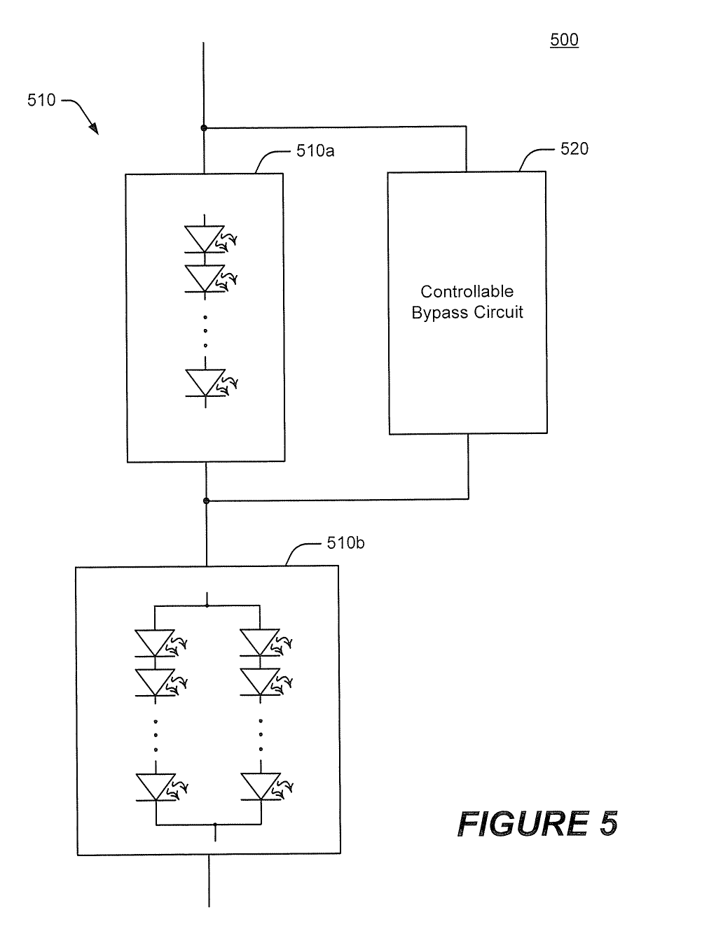

In some embodiments, different sets within a string may have different configurations. For example, in a lighting apparatus 500 shown in FIG. 5, a first set 510a of a string 510 includes a single string of LEDs, with a controllable bypass circuit 520 being connected across the set 510a at terminal nodes thereof. A second set 510b of LEDs of the string, however, may comprise two or more parallel-connected substrings of LEDs.

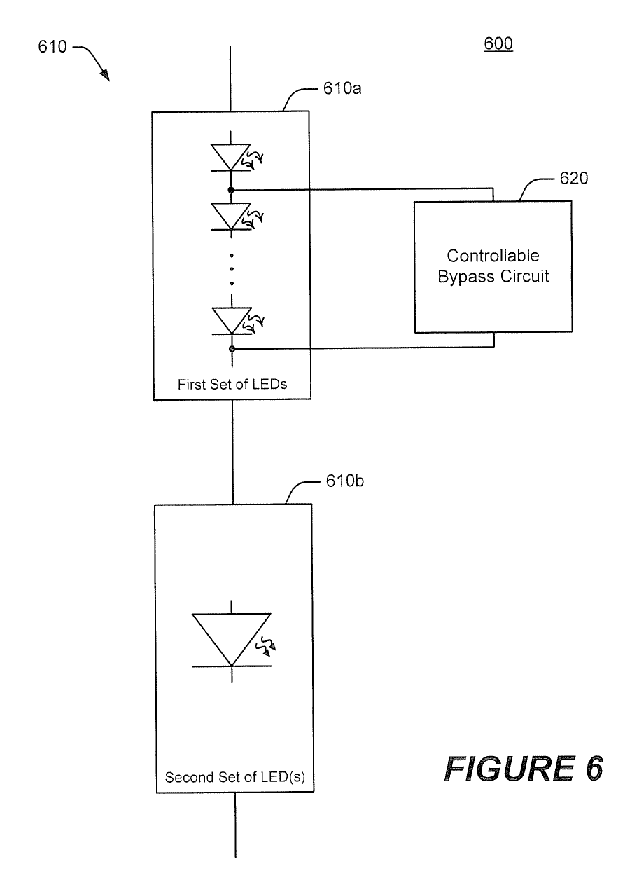

According to further embodiments, an entire set of LEDs may be bypassed, or individual LEDs within a given set may be bypassed. For example, in a lighting apparatus 600 shown in FIG. 6, in a string 610 including first and second sets 610a, 610b, each comprising a single string of LED's, a controllable bypass circuit 620 may be connected at an internal node in the first set 610a.

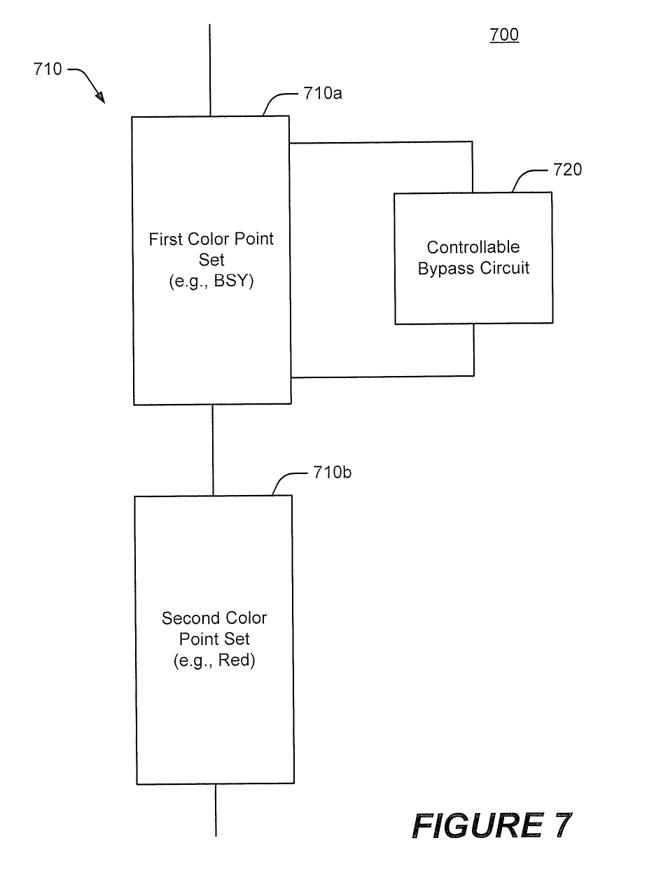

As noted above, in some embodiments of the present inventive subject matter, sets of LEDs may be defined in a number of different ways. For example, as shown in FIG. 7, a lighting apparatus 700 may include a string 710 including first and second color point sets 710a, 710b. As illustrated, for example, the first color point set 710 may comprise one or more LEDs falling within a generally BSY color point set, while the second color point set 710b may include one or more LEDs falling within a generally red color point set. It will be appreciated the LEDs within a given one of the color point set 710a, 710b may not have identical color point characteristics, but instead may fall within a given color point range such that the group, as a whole, provides an aggregate color point that is generally BSY, red or some other color.

As further shown in FIG. 7, a controllable bypass circuit 720 is configured to controllably bypass current around the first color point set 710a. Adjusting the amount of current bypassed around the first color point set 710 may provide for control of the amount of illumination provided by the first color point set 710 relative to the second color point set 710b, such that an aggregate color point of the string 710 may be controlled.

Some embodiments of the present inventive subject matter may have a variety of configurations where a load independent current (or load-independent voltage that is converted to a current) is provided to a string of LEDs. The term “load independent current” is used herein to refer to a current source that provides a substantially constant current in the presence of variations in the load to which the current is supplied over at least some range of load variations. The current is considered constant if it does not substantially alter the operation of the LED string. A substantial alteration in the operation of the LED string may include a change in luminous output that is detectable to a user. Thus, some variation in current is considered within the scope of the term “load independent current.” However, the load independent current may be a variable current responsive to user input or other control circuitry. For example, the load independent current may be varied to control the overall luminous output of the LED string to provide dimming, for lumen maintenance or to set the initial lumen output of the LED string.

In the illustrated embodiments of FIG. 7, the bypass circuit 720 is connected in parallel with the BSY color point set 710a of the LED string 710a so as to control the amount of current through the BSY color point set 710a. In particular, the string current I is the sum of the amount of current through the BSY portion 710a of the string 710 and the amount of current I_{B} passing through the bypass circuit 720. By increasing I_{B}, the amount of current passing through the BSY color point set 710a is decreased. Likewise, by decreasing the current I_{B} passing through the bypass circuit 720, the current passing through the BSY color point set 710a is increased. However, because the bypass circuit 720 is only parallel to the BSY color point set 710a, the current through the red color point set 710b remains the total string current I. Accordingly, the ratio of the contribution to the total light output provided by the BSY color point set 710a to that provided by the red color point set 710b may be controlled.

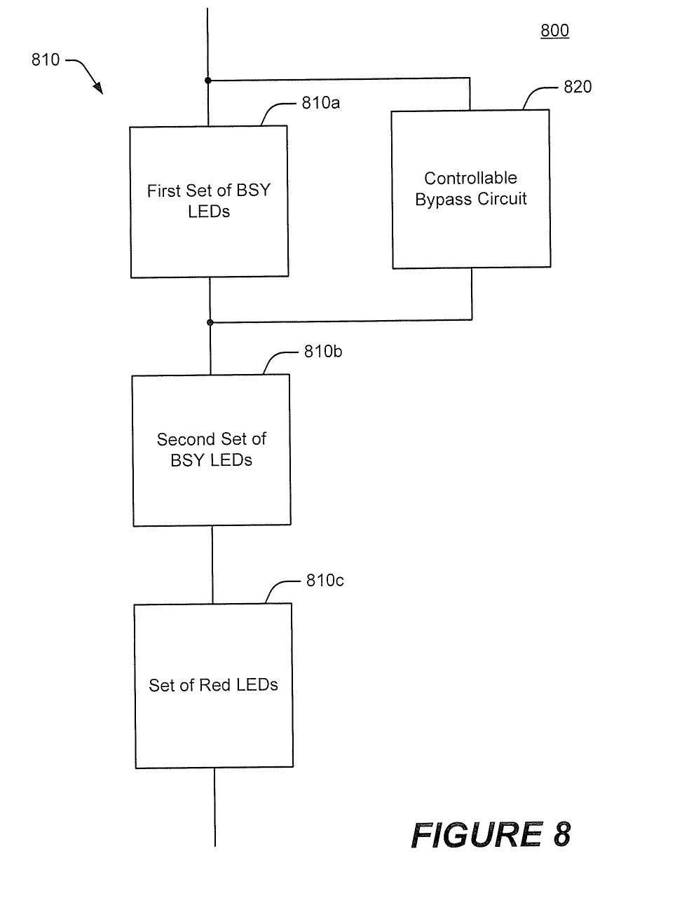

As illustrated in FIG. 8, in a lighting apparatus 800 according to some embodiments, a string may include first and second BSY color point sets 810a, 810b, along with a red color point set 810c. A controllable bypass circuit 820 is provided in parallel with only the first BSY color point set 810a. In other embodiments, more than one controllable bypass circuit could be employed, e.g., one for each of the first and second BSY color point groups 810a, 810b. Such a configuration may allow for moving the color point of the combined light output of the LED string 810 along a tie line between the color point of the first BSY color point set 810a and the color point of the second BSY color point set 810b. This may allow for further control of the color point of the string 810. In further embodiments, a controllable bypass circuit may be provided for the red color point set 810c as well.

It may be desirable that the amount of current diverted by a controllable bypass circuit be as little as possible, as current flowing through the bypass circuit may not be generating light and, therefore, may reduce overall system efficacy. Thus, the LEDs in a string may be preselected to provide a color point relatively close to a desired color point such that, when a final color point is fine tuned using a bypass circuit, the bypass circuit need only bypass a relatively small amount of current. Furthermore, it may be beneficial to place a bypass circuit in parallel with those LEDs of the string that are less constraining on the overall system efficacy, which may be those LEDs having the highest lumen output per watt of input power. For example, in the illustrated embodiments of FIGS. 7 and 8, red LEDs may be particularly limiting of overall system efficacy and, therefore, it may be desirable that a bypass circuit(s) be placed in parallel only with BSY portions of the LED string.

The amount of bypass current may be set at time of manufacture to tune an LED string to a specified color point when a load independent current is applied to the LED string. The mechanism by which the bypass current is set may depend on the particular configuration of the bypass circuit. For example, in embodiments in which a bypass circuit is a variable resistance circuit including, for example, a circuit using a bipolar or other transistor as a variable resistance, the amount of bypass current may be set by selection or trimming of a bias resistance. In further embodiments, the amount of bypass current may be adjusted according to a settable reference voltage, for example, a reference voltage set by zener zapping, according to a stored digital value, such as a value stored in a register or other memory device, and/or through sensing and/or or feedback mechanisms.

By providing a tunable LED module that operates from a load independent current source in a single string, power supplies for solid state lighting devices may also be less complex. Use of controllable bypass circuits may allow a wider range of LEDs from a manufacturer's range of LED color points to be used, as the control afforded by a bypass circuit may be used to compensate for color point variation. Some embodiments of the present inventive subject matter may provide an LED lighting apparatus that may be readily incorporated, e.g., as a replaceable module, into a lighting device without requiring detailed knowledge of how to control the current through the various color LEDs to provide a desired color point. For example, some embodiments of the present inventive subject matter may provide a lighting module that contains different color point LEDs but that may be used in an application as if all the LEDs were a single color or even a single LED. Also, because such an LED module may be tuned at the time of manufacture, a desired color point may be achieved from a wide variety of LEDs with different color points. Thus, a wider range of LEDs from a manufacturing distribution may be used to make a desirable color point than might be achievable through the LED manufacturing process alone.

Examples of the present inventive subject matter are described herein with reference to the different color point LEDs being BSY and red, however, the present inventive subject matter may be used with other combinations of different color point LEDs. For example, BSY and red with a supplemental color such as described in U.S. patent application Ser. No. 12/248,220, entitled “LIGHTING DEVICE AND METHOD OF MAKING” (Attorney Docket No. 931-040) filed Oct. 9, 2008, may be used. Other possible color combinations include, but are not limited to, red, green and blue LEDs, red, green, blue and white LEDs and different color temperature white LEDs. Also, some embodiments of the present inventive subject are described with reference to the generation of white light, but light with a different aggregate color point may be provided according to some embodiments of the present inventive subject matter.

In addition or alternatively, controllable bypass circuits may be used for other aspects of controlling the color point of the single string of LEDs. For example, controllable bypass circuits may be used to provide thermal compensation for LEDs for which the output changes with temperature. For example, a thermistor may be incorporated in a linear bypass circuit to either increase or decrease the current through the bypassed LEDs with temperature. In specific embodiments, the current flow controller may divert little or no current when the LEDs have reached a steady state operating temperature such that, at thermal equilibrium, the bypass circuit would consume a relatively small amount of power to maintain overall system efficiency. Other temperature compensation techniques using other thermal measurement/control devices may be used in other embodiments. For example, a thermocouple may be used to directly measure at a temperature sensing location and this temperature information used to control the amount of bypass current. Other techniques, such as taking advantage of thermal properties of transistor, could also be utilized.

According to further aspects of the present inventive subject matter, a bypass circuit may be used to maintain a predetermined color point in the presence of changes to the current passing through an LED string, such as current changes arising from a dimmer or other control. For example, many phosphor-converted LEDs may change color as the current through them is decreased. A bypass circuit may be used to alter the current through these LEDs or through other LEDs in a string as the overall current decreases so as to maintain the color point of the LED string. Such a compensation for changes in the input current level may be beneficial, for example, in a linear dimming application in which the current through the string is reduced to dim the output of the string. In further embodiments, current through selected sets of LEDs could be changed to alter the color point of an LED string. For example, current through a red string could be increased when overall current is decreased to make the light output seem wanner as it is dimmed.

A bypass circuit according to some embodiments of the present inventive subject matter may also be utilized to provide lumen depreciation compensation. As a typical phosphor converted LED is used over a long period of time (thousands of hours), its lumen output for a given current may decrease. To compensate for this lumen depreciation, a bypass circuit may sense the quantity of light output, the duration and temperature of operation or other characteristic indicative of potential or measured lumen depreciation and control bypass current to increase current through affected LEDs and/or route current through additional LEDs to maintain a relatively constant lumen output. Different actions in routing current may be taken based, for example, on the type and/or color point of the LEDs used in the string of LEDs.

In a string of LEDs including LEDs with different color points, the level of current at which the different LEDs output light may differ because of, for example, different material characteristics or circuit configurations. For example, referring to FIG. 7, the BSY color point set 710a may include LEDs that output light at a different current than the LEDs in the red color point set 710b. Thus, as the current through the string 710 is reduced, the LEDs in the red color point set 710b may turn off sooner than the LEDs in the BSY color point set 710a. This can result in an undesirable shift in color of the light output of the LED string 710, for example, when dimming. The bypass circuit 720 may be used to bypass current around the BSY color point set 710a when the overall string current I falls to a level where the LEDs of the red color point set 710b substantially cease output of light. Similarly, if the output of the different LEDs differs with differing string current I, the bypass circuit 720 may be used to increase and/or decrease the current through the LEDs so that the light output of the differing LEDs adjusts with the same proportion to current. In such a manner, the single string 710 may act like a single LED with the color point of the combined output of the LEDs in the string.

Further embodiments of the present inventive subject matter provide lighting apparatus that may be used as a self contained module that can be connected to a relatively standard power supply and perform as if the string of LEDs therein is a single component. Bypass circuits in such a module may be self powered, e.g., biased or otherwise powered from the same power source as the LED string. Such self-powered bypass circuits may also be configured to operate without reference to a ground, allowing modules to be interconnected in parallel or serial arrays to provide different lumen outputs. For example, two modules could be connected in series to provide twice the lumen output as the two modules in series would appear as a single LED string.

Bypass circuits may also be controlled responsive to various control inputs, separately or in combination. In some embodiments, separate bypass circuits that are responsive to different parameters associated with an LED string may be paralleled to provide multiple adjustment functions. For example, in a string including BSY and red LEDs along the lines discussed above with reference to FIGS. 7 and 8, temperature compensation of red LEDs achieved by reducing current through BSY LEDs may be combined with tuning input control of current through the BSY LEDs that sets a desired nominal color point for the string. Such combined control may be achieved, for example, by connecting a bypass circuit that sets the color point in response to an external input in parallel with a bypass circuit that compensates for temperature.

Some embodiments of the present inventive subject matter provide fabrication methods that include color point adjustment using one or more bypass circuits. Using the adjustment capabilities provided by bypass circuits, different combinations of color point bin LEDs can be used to achieve the same final color point, which can increase flexibility in manufacturing and improve LED yields. The design of power supplies and control systems may also be simplified.

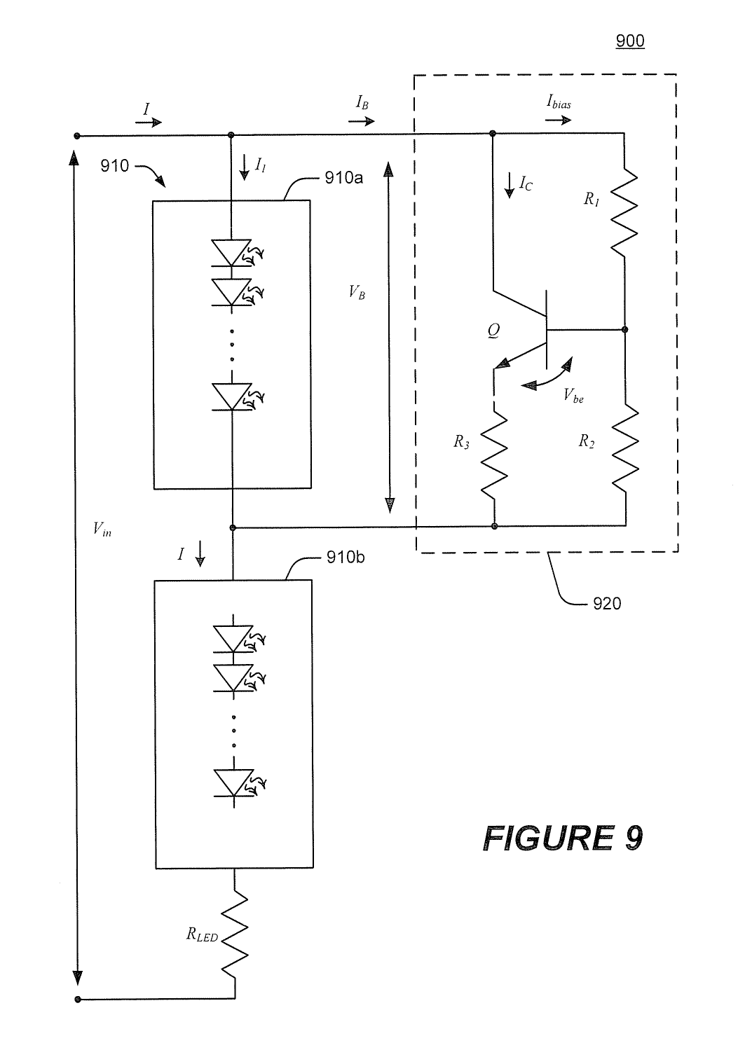

As noted above, various types of bypass circuits may be employed to provide the single string of LEDs with color control. FIG. 9 illustrates a lighting apparatus 900 according to some embodiments of the present inventive subject matter. The apparatus 900 includes a string 910 of LEDs including first and second sets 910a, 910b, and a bypass circuit 920 that may be used to set the color point for the LED string 910. The first and second sets 910a, 910b may correspond, for example, to BSY and red color point groups. The number of LEDs shown is for purposes of illustration, and the number of LEDs in each set 910a, 910b may vary, depending on such factors as the desired total lumen output, the particular LEDs used, the binning structure of the LEDs and/or the input voltage/current.

In FIG. 9, a voltage source provides a constant input voltage Vᵢₙ. The constant voltage Vᵢₙ is turned into a constant current I through the use of the current limiting resistor R_{LED}. In other words, if Vᵢₙ is constant, the voltage across the LED string 910 is set by the forward voltages of the LEDs of the string 910 and, thus, the voltage across the resistor R_{LED} will be substantially constant and the current I through the string 910 will also be substantially constant per Ohm's law. Thus, the overall current, and therefore the lumen output, may be set for the lighting apparatus 900 by the resistor R_{LED}. Each lighting apparatus 900 may be individually tuned for lumen output by selecting the value of the resistor R_{LED} based on the characteristics of the individual LEDs in the lighting apparatus 900. The current I₁ through the first set 910a of LEDs and the current I_{B} through the bypass circuit 920 sum to provide the total current I:

I=I₁+I_{B}.

Accordingly, a change in the bypass current I_{B} will result in an opposite change in the current I₁ through the first set 910a of LEDs. Alternatively, a constant current source could be utilized and R_{LED} could be eliminated, while using the same control strategy.

Still referring to FIG. 9, the bypass circuit 920 includes a transistor Q1, resistors R₁, R₂ and R₃. The resistor R7 may be, for example, a thermistor, which may provide the bypass circuit 920 with the ability to provide thermal compensation. If thermal compensation is not desired, the resistor R₂ could be a fixed resistor. As long as current flows through the string 910 of LEDs (i.e., Vᵢₙ is greater than the sum of the forward voltages of the LEDs in the string 910), the voltage V_{B} across the terminals of the bypass circuit 920 will be fixed at the sum of the forward voltages of the LEDs in the first set 910a of LEDs. Assuming:

(β+1)R₃>>R₁∥R₂,

then the collector current through the transistor Q1 may be approximated by:

I_{C}=(V_{B}/(1+R₁/R₂)−V_{be})/R₃,

where R₁∥R₂ is the equivalent resistance of the parallel combination of the resistor R₁ and the resistor R₂ and V_{be} is the base-to-emitter voltage of the transistor Q1. The bias current I_{bias} may be assumed to be approximately equal to V_{B}/(R₁+R₂), so the bypass current I_{B} may be given by:

I_{B}=I_{C}+I_{bias}=(V_{B}/(1+R₁/R₂)−V_{be})/R_{E}+V_{B}/(R₁+R₂).

If the resistor R7 is a thermistor, its resistance may be expressed as a function of temperature, such that the bypass current I_{B} also is a function of temperature.

Additional embodiments provide lighting apparatus including a bypass circuit incorporating a switch controlled by a pulse width modulation (PWM) controller circuit. In some embodiments, such a bypass circuit may be selectively placed in various locations in a string of LEDs without requiring a connection to a circuit ground. In some embodiments, several such bypass circuits may be connected to a string to provide control on more than one color space axis, e.g., by arranging such bypass circuits in a series and/or hierarchical structure. Such bypass circuits may be implemented, for example, using an arrangement of discrete components, as a separate integrated circuit, or embedded in an integrated multiple-LED package. In some embodiments, such a bypass circuit may be used to achieve a desired color point and to maintain that color point over variations in current and/or temperature. As with other types of bypass circuits discussed above, it may also include means for accepting control signals from, and providing feedback to, external circuitry. This external circuitry could include a driver circuit, a tuning circuit, or other control circuitry.

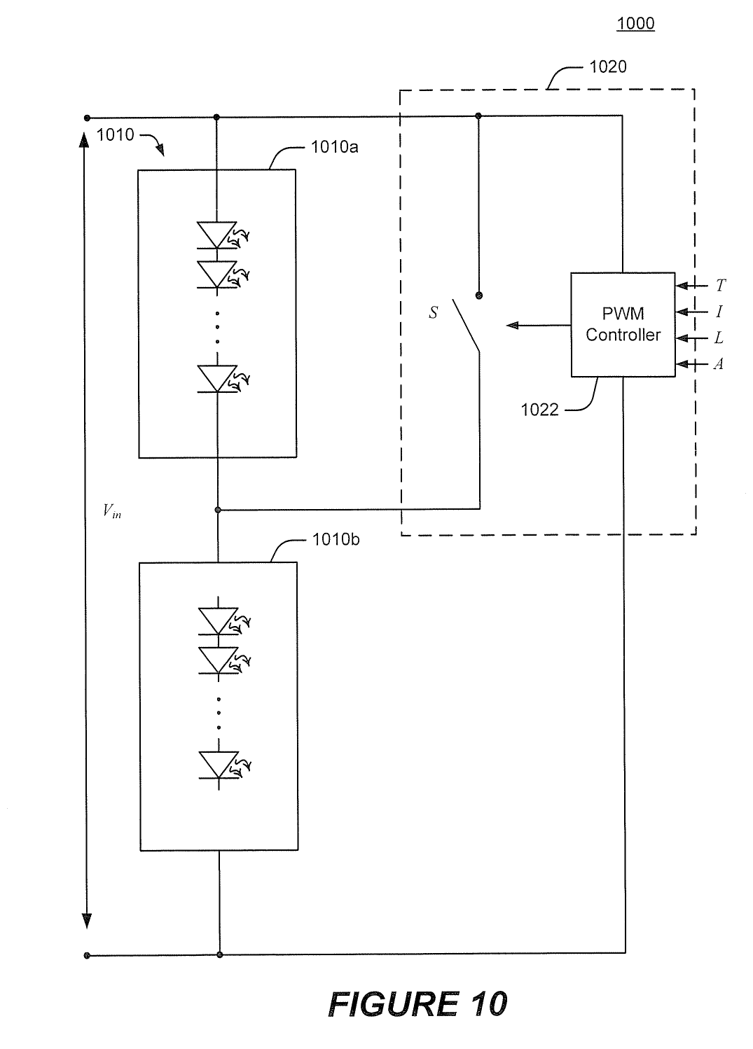

FIG. 10 illustrates a lighting apparatus 1000 including a string of LED's 1010 including first and second sets 1010a, 1010b of LEDs. A bypass circuit 1020 is connected in parallel with the first set 1010a of LEDs and includes a switch S that is controlled by a PWM controller circuit 1022. As shown, the PWM controller circuit 1022 may control the switch S responsive to a variety of control inputs, such as temperature T, string current I, light L (e.g., light output of the string 1010 or some other source) and/or an adjustment input A, such as may be provided during a calibration procedure. The PWM controller circuit 1022 may include, for example, a microprocessor, microcontroller or other processor that receives signals representative of the temperature T, the string current I and/or the tuning input Tune from various sensors, and responsively generates a PWM signal that drives the switch S.

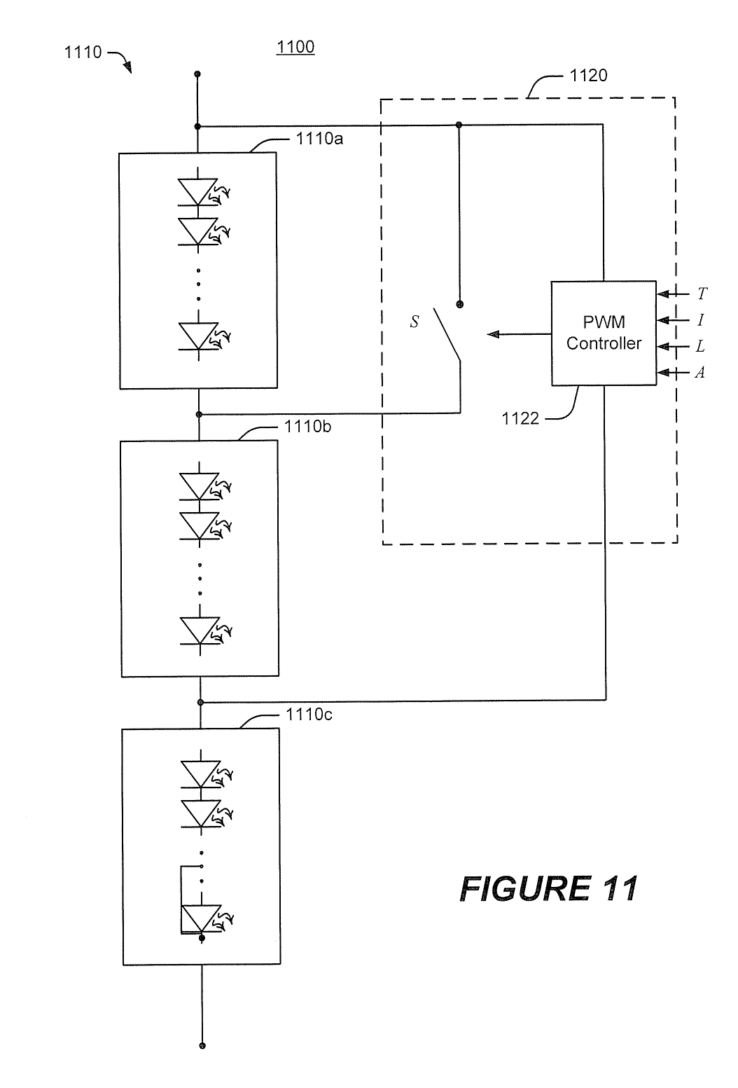

In the embodiments illustrated in FIG. 10, the PWM controller circuit 1022 has power input terminals connected across the string 1010, such that it may be powered by the same power source that powers the string 1010. In embodiments of the present inventive subject matter illustrated in FIG. 11, a lighting device 1100 includes a string 1110 including first, second and third sets 1110a, 1110b, 1110c. A bypass circuit 1120 is configured to bypass the first set 1110a, and includes a PWM controller circuit 1122 having power terminals connected across the first and second sets 1110a, 1110b, 1110c. Such a configuration may be used, for example, to provide a module that may be coupled to or more internal nodes of a string without requiring reference to a circuit ground, with the second set 1110b of LEDs providing sufficient forward voltage to power the PWM controller circuit 1122.

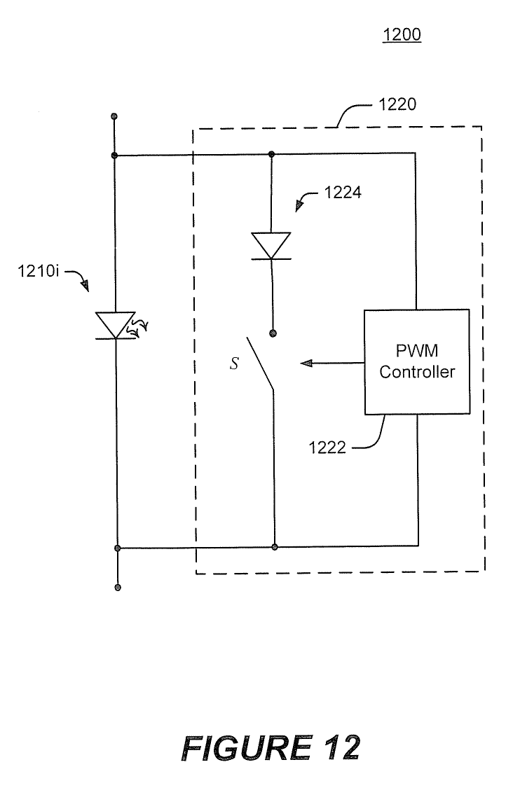

According to further embodiments of the present inventive subject matter, a bypass switch may include an ancillary diode through which bypass current is diverted. For example, FIG. 12 illustrates a lighting apparatus including an LED set 1210i (e.g., a portion of an LED string including multiple serially connected LED sets) having one or more LEDs, across which a bypass circuit 1220 is connected. The bypass circuit 1220 includes a switch S connected in series with an ancillary diode set 1224, which may include one or more emitting diodes (e.g., LEDs or diodes emitting energy outside the visible range, such as energy in the infrared, ultraviolet or other portions of the spectrum) and/or one or more non-emitting diodes. Such an ancillary diode set 1224 may be used, for example, to provide a compensatory LED output (e.g., an output of a different color point) and/or to provide other ancillary functions, such as signaling (e.g., using infrared or ultraviolet). The ancillary diode set may be provided so that switching in the ancillary diode set does not substantially affect the overall string voltage. A PWM controller circuit 1222 controls the switch S to control diversion of current through the ancillary diode set 1224. The PWM controller circuit 1222 may be powered by the forward voltages across the diode set 1210i and the ancillary diode set 1224. The ancillary diode set 1224 has a forward voltage lower than that of the LED set 1210i, but high enough to power the PWM controller circuit 1222.

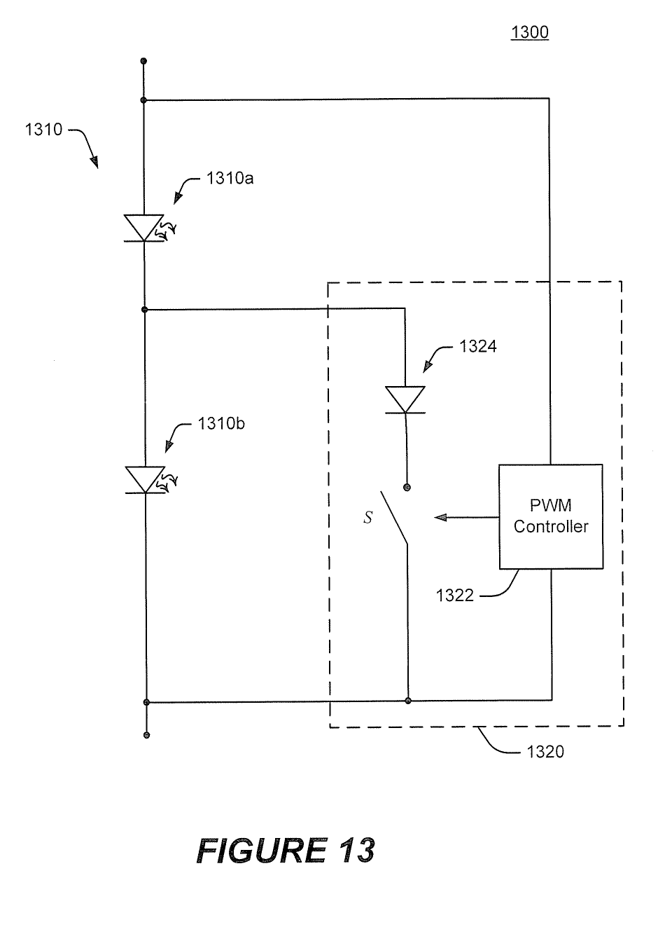

FIG. 13 illustrates a lighting apparatus 1300 having an LED string 1310 including first and second sets 1310a, 1310b of LEDs. A bypass circuit 1320 is connected across the second set 1310b of LEDs, and includes a bypass path including a switch S connected in series with an ancillary diode set 1324. The forward voltage of the ancillary diode set 1324 may be less than that of the second set of diodes 1310b, and the sum of the forward voltages of the ancillary diode set 1324 and the first set 1310a of LEDs may be great enough to power a PWM controller circuit 1322 of the bypass circuit 1320.

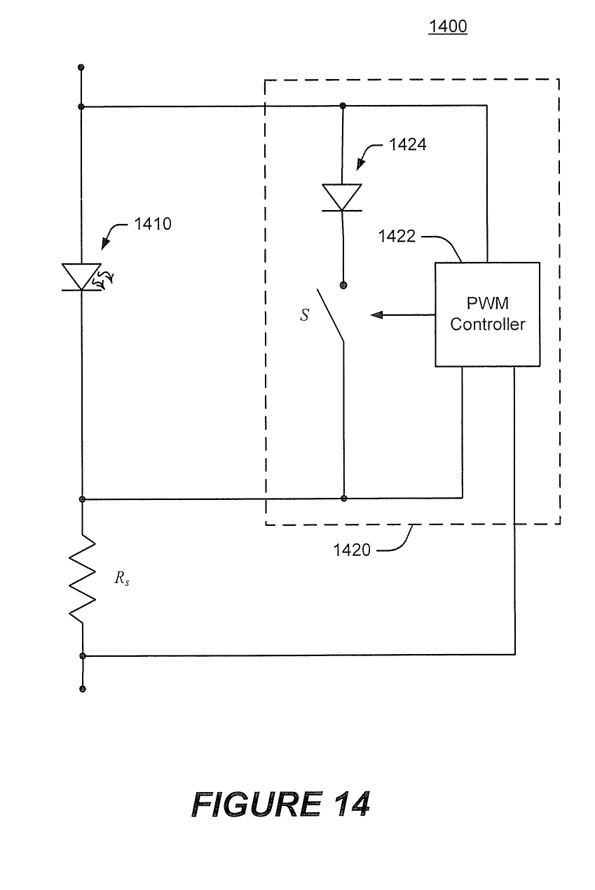

FIG. 14 illustrates a lighting apparatus 1400 including a bypass circuit 1420 that bypass current around an LED set 1410i (e.g., a portion of a string containing multiple serially connected sets of LEDs) via an ancillary diode set 1424 using a PWM controlled switch S. The bypass circuit 1420 includes a PWM controller circuit 1422 that controls the switch S responsive to a current sense signal (voltage) Vₛₑₙₛₑ developed by a current sense resistor Rₛₑₙₛₑ connected in series with the LED set 1410i. Such an arrangement allows the PWM duty cycle to be adjusted to compensate for variations in the string current I. An internal or external temperature sensor could be used in conjunction with such current-based control to adjust the duty cycle as well.

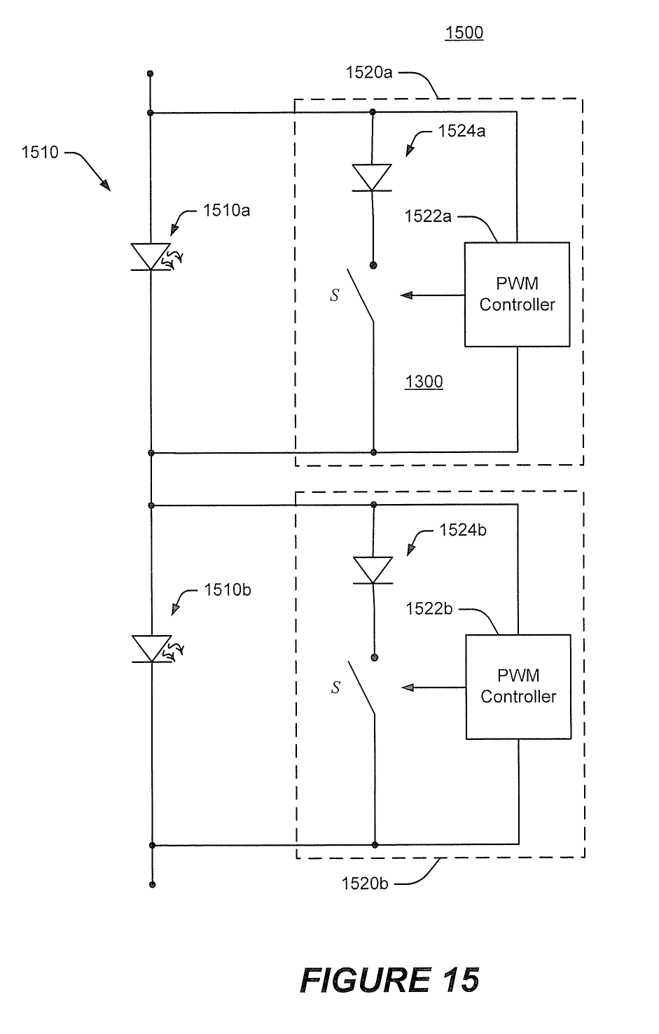

As noted above, different types of control inputs for bypass circuits may be used in combination. For example, FIG. 15 illustrates a lighting apparatus 1500 including an LED string 1510 including respective first and second LED sets 1510a, 1510b having respective bypass circuits 1520a, 1520b connected thereto. The bypass circuits 1520a, 1520b each include a series combination of an ancillary diode set 1524a, 1524b and a switch Sa, Sb controlled by a PWM controller circuit 1522a, 1522b. The ancillary diode sets 1524a, 1524b may have the same or different characteristics, e.g., may provide different wavelength light emissions. The PWM controller circuits 1522a, 1522b may operate in the same or different manners. For example, one of the controllers 1522a, 1522b may operate responsive to temperature, while another of the controllers may operate responsive to an externally-supplied tuning input.

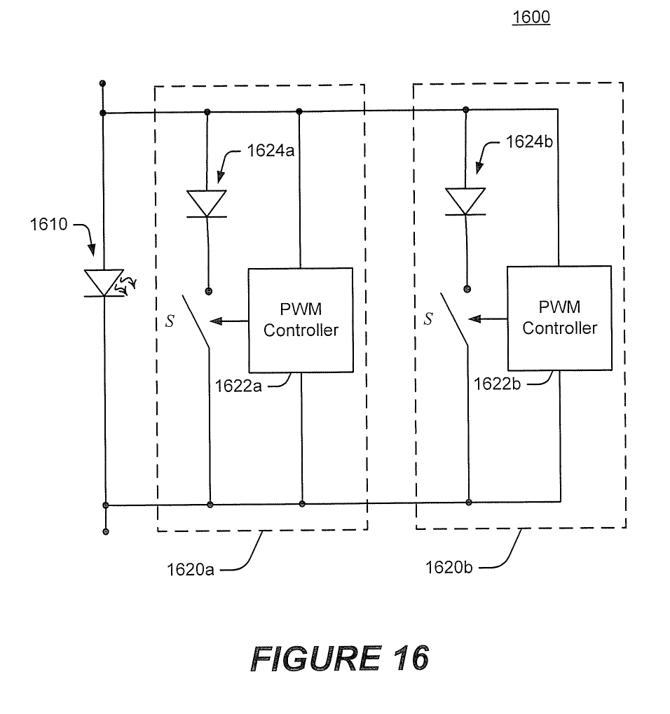

Several instances of such bypass circuits could also be nested within one another. For example, FIG. 16 illustrates a lighting apparatus 1600 including an LED set 1610i and first and second bypass circuits 1620a, 1620b connected in parallel with the LED set 1610i. The first and second bypass circuits 1620a, 1620b include respective first and second ancillary diode sets 1624a, 1624b connected in series with respective first and second switches Sa, Sb that are controlled by respective first and second PWM controller circuits 1622a, 1622b. In some embodiments, this arrangement may be hierarchical, with the first ancillary diode set 1624a having the lowest forward voltage and the LED set 1610i having the highest forward voltage. Thus, the first bypass circuit 1620a (the “dominant” bypass circuit) overrides the second bypass circuit 1620b (the “subordinate” bypass circuit). The second bypass circuit 1620b may operate when the switch Sa of the first bypass circuit 1620a is open. It may be necessary for the dominant bypass circuit to utilize a sufficiently lower PWM frequency than the subordinate bypass circuit so as to avoid seeing a color fluctuation due to interference of the two frequencies.

It will be appreciated that various modifications of the circuitry shown in FIGS. 2-16 may be provided in further embodiments of the present inventive subject matter. For example, the PWM-controlled switches shown in FIGS. 12-16 could be replaced by variable resistance elements (e.g., a transistor controlled in a linear manner along the lines of the transistor Q in the circuit of FIG. 9). In some embodiments, linear and PWM-based bypass circuits may be combined. For example, a linear bypass circuit along the lines discussed above with reference to FIG. 9 could be used to provide temperature compensation, while employing a PWM-based bypass circuit to support calibration or tuning. In still further embodiments, a linear temperature compensation bypass circuit along the lines discussed above with reference to FIG. 9 may be used in conjunction with a PWM-based temperature compensation circuit such that, at string current levels below a certain threshold, the PWM-based bypass circuit would override the linear bypass circuit. It will be further appreciated that the present inventive subject matter is applicable to lighting fixtures or other lighting devices including single strings or multiple strings of light emitting devices controlled along the lines described above.

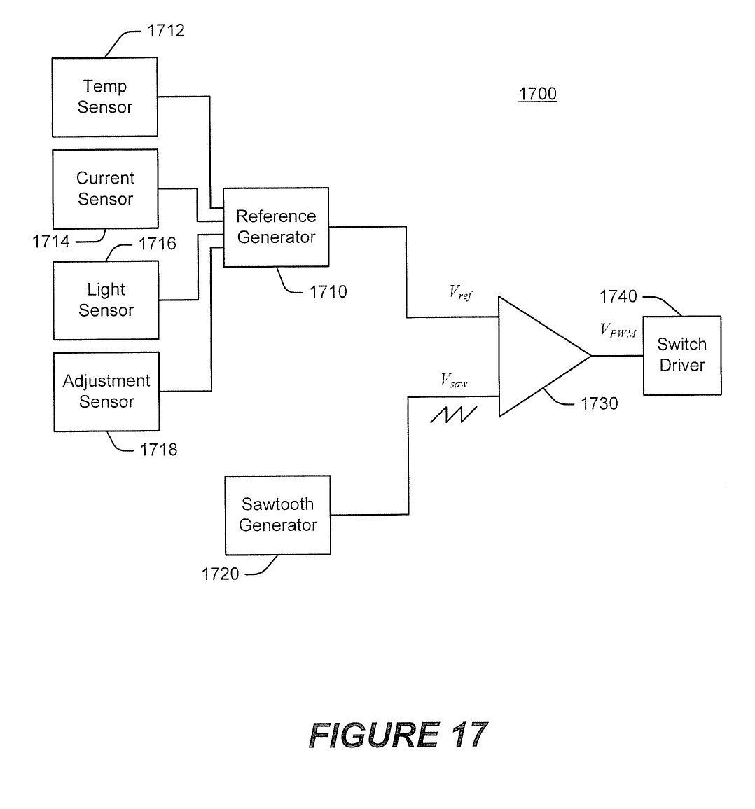

FIG. 17 illustrates an exemplary PWM controller circuit 1700 that could be used in the circuits shown in FIGS. 10-16 according to some embodiments of the present inventive subject matter. The PWM controller circuit 1700 includes a reference signal generator circuit 1710 that receives input signals from sensors, here shown as including a temperature sensor 1712, a string current sensor 1714, a light sensor 1716 and an adjustment sensor 1718. The reference signal generator circuit 1710 responsively produces a reference signal V_{ref} that is applied to a first input of a comparator circuit 1730. A sawtooth generator circuit 1720 generates a sawtooth signal V_{saw} that is applied to a second input of the comparator circuit 1730, which produces a pulse-width modulated control signal V_{PWM} based on a comparison of the reference signal V_{ref} and the sawtooth signal V_{saw}. The pulse-width modulated control signal V_{PWM} may be applied to a switch driver circuit 1740 that drives a switch, such as the switches shown in FIGS. 10-16.

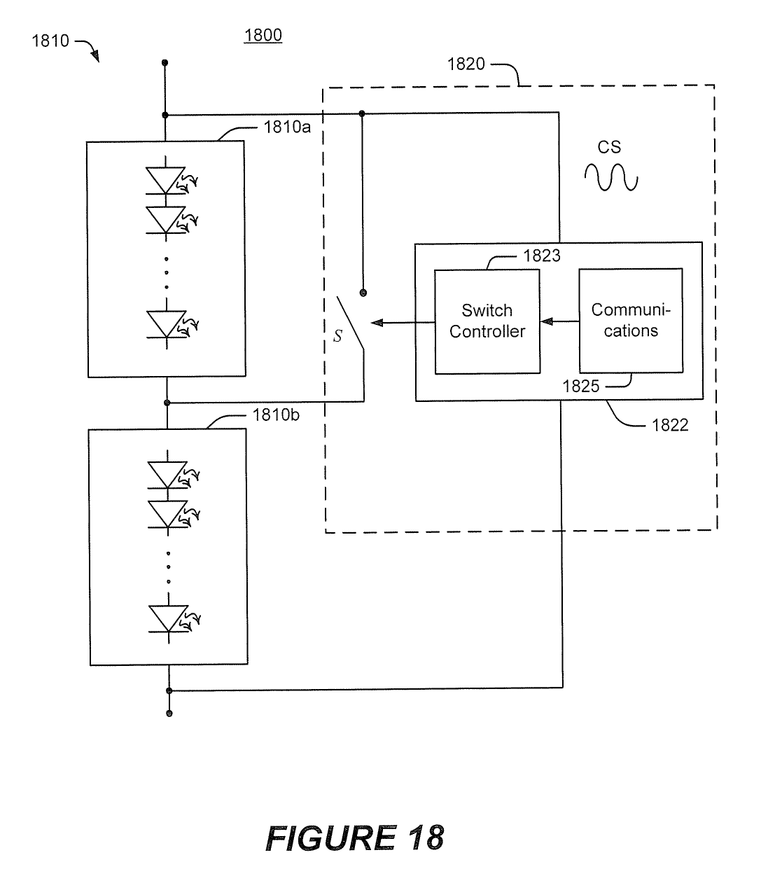

According to yet further aspects of the present inventive subject matter, a bypass circuit along the lines discussed above may also have the capability to receive information, such as tuning control signals, over the LED string it controls. For example, FIG. 18 illustrates a lighting apparatus 1800 including an LED string 1810 including first and second sets 1810a, 1810b of LEDs. The first set 1810a of LEDs has a bypass circuit 1820 connected in parallel. The bypass circuit 1820 includes a switch S controlled by a PWM controller circuit 1822. As illustrated, the PWM controller circuit 1822 includes a communications circuit 1825 and a switch controller circuit 1823. The communications circuit 1825 may be configured, for example, to receive a control signal CS propagated over the LED string 1810. For example, the control signal CS may be a carrier-modulated signal that conveys tuning commands or other information to the communications circuit 1825 (e.g., in the form of digital bit patterns), and the communications circuit 1825 may be configured to receive such a communications signal. The received information may be used, for example, to control the switch controller circuit 1823 to maintain a desired bypass current through the bypass circuit 1820. It will be appreciated that similar communications circuitry may be incorporated in variable resistance-type bypass circuits.

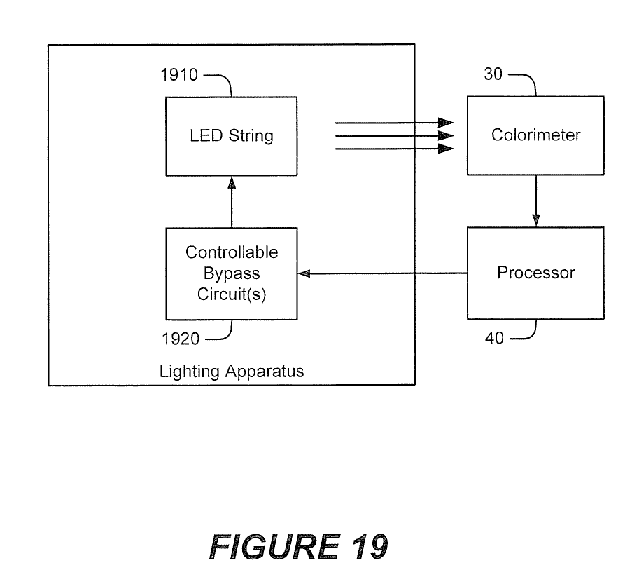

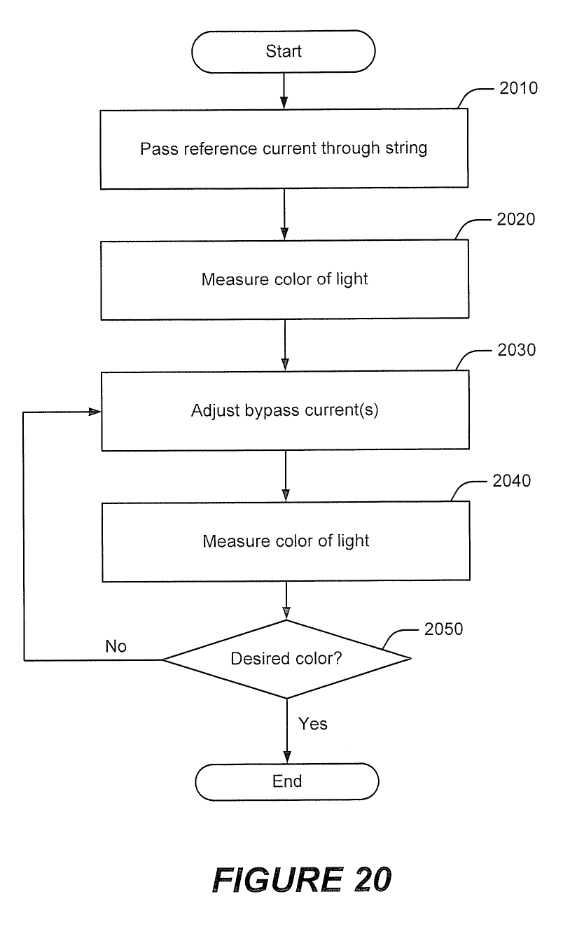

FIGS. 19 and 20 illustrate systems/methods for calibration of a lighting apparatus 1900 according to some embodiments of the present inventive subject matter. The lighting apparatus 1900 includes an LED string 1910 and one or more controllable bypass circuits 1920, which may take one of the forms discussed above. As shown, the controllable bypass circuit(s) 1920 is configured to communicate with a processor 40, i.e., to receive adjustment inputs therefrom. Light generated by the LED string 1910 is detected by a colorimeter 30, for example, a PR-650 SpectraScan® Colorimeter from Photo Research Inc., which can be used to make direct measurements of luminance, CIE Chromaticity (1931 xy and 1976 u′V′) and/or correlated color temperature. A color point of the light may be detected by the colorimeter 30 and communicated to the processor 40. In response to the detected color point of the light, the processor 40 may vary the control input provided to the controllable bypass circuit(s) 1920 to adjust a color point of the LED string 1910. For example, along lines discussed above, the LED string 1910 may include sets of BSY and red LEDs, and the control input provided to the controllable bypass circuit(s) 1920 may selectively bypass current around one or more of the BSY LEDs.

Referring to FIG. 20, calibration operations for the lighting apparatus 1900 of FIG. 19 may begin with passing a reference current (e.g., a nominal expected operating current) through the LED string 1910 (block 2010). The light output by the string 1910 in response to the reference current is measured (block 2020). Based on the measured light, the processor 40 adjusts the bypass current(s) controlled by the controllable bypass circuit(s) 1920 (block 2030). The light color is measured again (block 2040) and, if it is determined that a desired color is yet to be achieved (block 2050), the processor 40 again causes the controllable bypass circuit(s) 1920 to further adjust the bypass current(s) (block 2030). The calibration process may be terminated once a desired color is achieved.

In various embodiments of the present inventive subject matter, such calibration may be done in a factory setting and/or in situ. In addition, such a calibration procedure may be performed to set a nominal color point, and further variation of bypass current(s) may subsequently be performed responsive to other factors, such as temperature changes, light output changes and/or string current changes arising from dimming and other operations, along the lines discussed above.

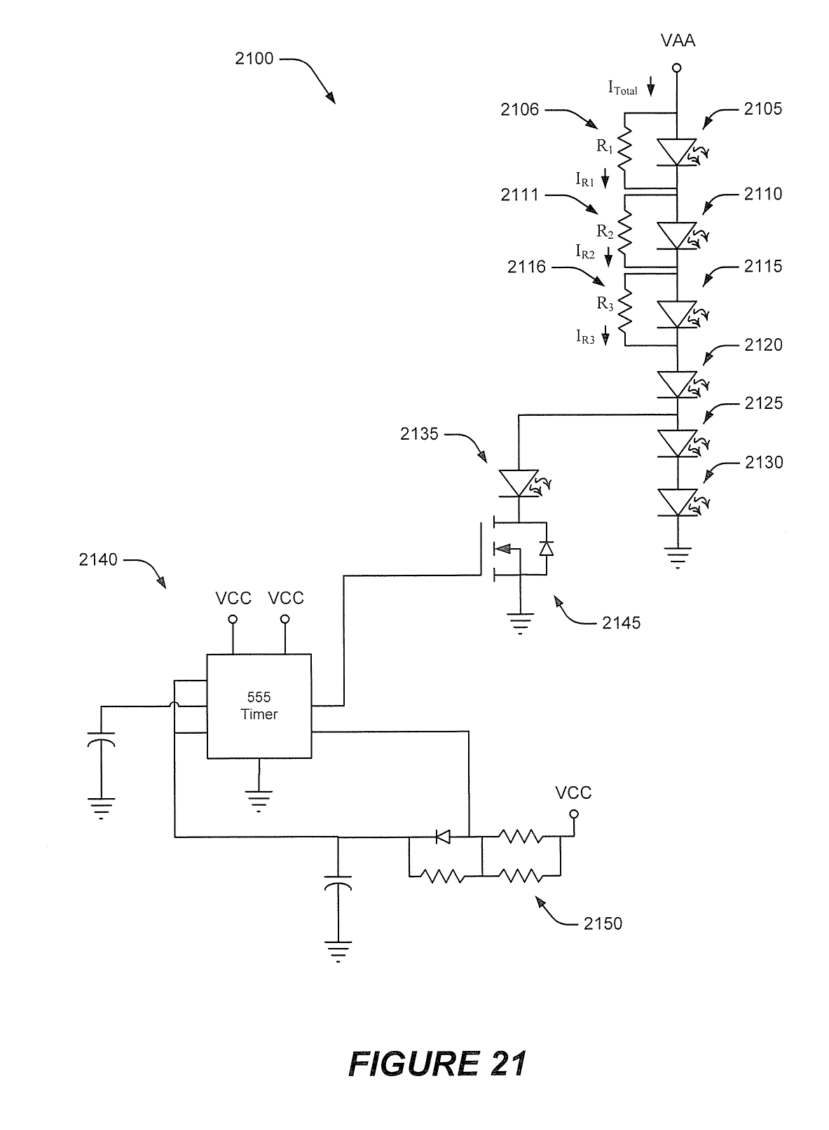

FIG. 21 illustrates a lighting apparatus 2100 incorporating further embodiments of the present inventive subject matter. As seen in FIG. 19, a string of LEDs includes serially interconnected device sets, including BSY LED sets 2105, 2110, 2115 red LED sets 2120, 2125, 2130. The BSY LED sets 2105, 2110 and 2115 have corresponding fixed bypass circuits 2106, 2111, 2116 (resistors R₁, R₂, R₃). The red LED device sets 2125 and 2130 have a corresponding controllable bypass circuit including a timer circuit 2140 controlled responsive to a negative temperature coefficient thermistor 2150, a switch 2145 controlled by the timer circuit 2140 and an ancillary BSY LED 2135.

The fixed bypass circuits 2106, 2111 and 2116 are provided to compensate for changes in color that may result when linear dimming is performed on the string of LEDs. In linear dimming, the total current Iₜₒₜₐₗ through the string is reduced to dim the output of the LEDs. The addition of the fixed resistance values in the bypass circuits 2106, 2111, 2116 provides a reduction in LED current that increases at a rate that is greater than the rate at which the total current Iₜₒₜₐₗ is reduced. For example, in FIG. 21, the currents I_{R1}, I_{R2}, I_{R3} through the fixed resistors R₁, R₂, R₃ are based on the forward voltage drop across the BSY LED sets 2105, 2110 and 2115 and are, therefore, substantially fixed. The current through the red LED 2120 is equal to the total current I_{Total} through the string. The current through the red LED sets 2125, 2130 is equal to the total current through the string when the switch 2145 is open.

The color point of the string may be set when the string is driven at full current. When the drive current I_{Total} is reduced during dimming, the currents I_{R1}, I_{R2}, I_{R3}; through the resistors R₁, R₂, R₃ remain constant, such that the current through the LED set 2105 is I_{Total}−I_{R1}, the current through the LED set 2110 is I_{Total}−I_{R2} and the current through the LED set 2115 is I_{Total}−I_{R3}. If the currents I_{R1}, I_{R2}, I_{R3} through the resistors R₁, R₂, R₃ are 10% of the full drive current, when the drive current is reduced to 50% of full drive current, the fixed currents (I_{R1}, I_{R3}) become 20% of the total and, therefore, rather than being drive at 50% of their original full drive current, the LED sets 2105, 2110 and 2115 are driven at 40% of their original drive current. In contrast, the red LED sets 2120, 2125 and 2130 are driven at 50% of their original drive current. Thus, the rate at which the current is reduced in the BSY LED sets may be made greater than the rate at which the current is reduced in the red LED sets to compensate for variations in the performance of the LEDs at different drive currents. Such compensation may be used to maintain color point or predictably control color shift over a range of dimming levels.

FIG. 21 also illustrates the use of timer circuit 2140 with a thermistor 2150 being utilized to vary the duty cycle of the timer circuit 2140 that drives the switch 2145. As temperature increases, the time the switch 2145 is on may be decreased to compensate for the reduction in red LED performance with temperature.

In the drawings and specification, there have been disclosed typical embodiments of the present inventive subject matter and, although specific terms are employed, they are used in a generic and descriptive sense only and not for purposes of limitation, the scope of the present inventive subject matter being set forth in the following claims.

That which is claimed is:

1. A lighting apparatus comprising:
a string comprising a plurality of serially-connected light emitting device sets, each set comprising at least one light emitting device; and
at least one controllable bypass circuit configured to variably bypass current around at least one light emitting device of a set of the plurality of light emitting device sets responsive to a control input.

2. The apparatus of claim 1, wherein the plurality of light emitting device sets includes a plurality of color point sets.

3. The apparatus of claim 2, wherein the plurality of color point sets comprises a set of nominally blue-shifted yellow (BSY) light emitting diodes (LEDs) and a set of nominally red LEDs.

4. The apparatus of claim 3, wherein the at least one controllable bypass circuit is configured to variably bypass current around at least one LED of the set of nominally BSY LEDs.

5. The apparatus of claim 1, wherein the at least one controllable bypass circuit comprises a plurality of controllable bypass circuits, respective ones of which are configured to variably bypass respective currents around at least one light emitting device of respective ones of the plurality of light emitting device sets.

6. The apparatus of claim 1, wherein the at least one controllable bypass circuit comprises a plurality of controllable bypass circuit connected in parallel with the at least one light emitting device and configured to variably bypass current around the at least one light emitting device responsive to respective control inputs.

7. The apparatus of claim 1, wherein the at least one controllable bypass circuit comprises a variable resistance circuit.

8. The apparatus of claim 7, wherein the variable resistance circuit is configured to vary the bypass current responsive to temperature.

9. The apparatus of claim 1, wherein the at least one controllable bypass circuit comprises:
a switch configured to couple and decouple circuit nodes connected to the at least one light emitting device; and
a PWM controller circuit configured to operate the switch responsive to the control input.

10. The apparatus of claim 1, wherein the control input comprises a temperature input, a string current sense input and/or an adjustment input.

11. The apparatus of claim 1, wherein the at least one controllable bypass circuit is configured to be powered via at least one node of the string.

12. The apparatus of claim 11, wherein the at least one controllable bypass circuit is configured to be powered by a forward voltage across at least one light-emitting device in the string.

13. The apparatus of claim 1, wherein the at least one controllable bypass circuit comprises a communications circuit configured to receive the control input via the string.

14. The apparatus of claim 1, wherein the control input comprises a fixed input that establishes an initial color point light output of the apparatus.

15. A lighting apparatus comprising:
a string comprising at least one LED; and
at least one controllable bypass circuit configured to variably bypass current around at the at least one LED via at least one ancillary diode having a different forward voltage characteristic than the at least one LED responsive to a control input.

16. The apparatus of claim 15:
wherein the string comprises a plurality of serially-connected LED sets, each set comprising at least one LED; and
wherein the at least one LED comprises at least one LED of a set of the plurality of LED sets.

17. The apparatus of claim 15, wherein the control input comprises a temperature input, a string current sense input and/or an adjustment input.

18. The apparatus of claim 15, wherein the at least one ancillary diode comprises at least one ancillary LED.

19. The apparatus of claim 18, wherein the at least one ancillary LED has a different color point than the at least one LED.

20. The apparatus of claim 15, wherein the at least one ancillary diode is configured to emit non-visible electromagnetic radiation.

21. The apparatus of claim 15, wherein the at least one controllable bypass circuit comprises:
a switch connected in series with the ancillary diode and configured to couple and decouple circuit nodes connected to the at least one LED; and
a PWM controller circuit configured to operate the switch responsive to the control input.

22. The apparatus of claim 15, wherein the at least one controllable bypass circuit is configured to be powered via at least one node of the string.

23. The apparatus of claim 22, wherein the at least one controllable bypass circuit is configured to be powered by a forward voltage across the at least one ancillary diode.

24. The apparatus of claim 15, wherein the at least one controllable bypass circuit comprises a plurality of controllable bypass circuits, respective ones of which are configured to variably bypass respective currents around respective at least one LEDs.

25. The apparatus of claim 15, wherein the at least one controllable bypass circuit comprises a plurality of controllable bypass circuit connected in parallel with the at least one LED and configured to variably bypass current around the at least one LED responsive to respective control inputs.

26. The apparatus of claim 15, wherein the at least one controllable bypass circuit comprises a variable resistance circuit.

27. The apparatus of claim 15, wherein the control input comprises a fixed input that establishes an initial color point light output of the apparatus.

28. A method of operating a lighting apparatus comprising a string comprising a plurality of serially-connected light emitting device sets, each set comprising at least one light emitting device, the method comprising:
bypassing current around at least one light emitting device of a set of the plurality of light emitting device sets responsive to a control input.

29. The method of claim 28, wherein the plurality of light emitting device sets includes a plurality of color point sets.

30. The method of claim 29, wherein the plurality of color point sets comprises a set of nominally blue-shifted yellow (BSY) light emitting diodes (LEDs) and a set of nominally red LEDs.

31. The method of claim 30, wherein bypassing current around at least one light emitting device of a set of the plurality of light emitting device sets responsive to a control input comprises bypassing current around at least one LED of the set of nominally BSY LEDs.

32. The method of claim 28, wherein bypassing current around at least one light emitting device of a set of the plurality of light emitting device sets responsive to a control input comprises bypassing respective currents around at least one light emitting device of respective ones of the plurality of light emitting device sets.

33. The method of claim 28, wherein bypassing current around at least one light emitting device of a set of the plurality of light emitting device sets responsive to a control input comprises bypassing current around the at least one light emitting device via respective bypass paths responsive to respective control inputs.

34. The method of claim 28, wherein bypassing current around at least one light emitting device of a set of the plurality of light emitting device sets responsive to a control input comprises controlling a switch and/or a variable resistance circuit connected in parallel with the at least one light emitting device.

35. The method of claim 34, wherein controlling a switch and/or a variable resistance circuit connected in parallel with the at least one light emitting device comprises controlling the switch and/or the variable resistance circuit responsive to a temperature, a string current and/or an adjustment input.

36. The method of claim 28, further comprising varying the control input to adjust a color point of the string.

37. A method of operating a lighting apparatus comprising a string comprising at least one LED, the method comprising:
bypassing current around at the at least one LED via at least one ancillary diode having a different forward voltage characteristic than the at least one LED responsive to a control input.

38. The method of claim 37, wherein the control input comprises a temperature input, a string current sense input and/or an adjustment input.

39. The method of claim 37, wherein the at least one ancillary diode comprises at least one ancillary LED.

40. The method of claim 37, wherein the at least one ancillary diode is configured to emit non-visible electromagnetic radiation.

41. The method of claim 37, wherein bypassing current around at the at least one LED via at least one ancillary diode having a different forward voltage characteristic than the at least one LED responsive to a control input comprises variably conducting current through the ancillary diode using a switch and/or a variable resistance circuit.

42. The method claim 37, further comprising varying the control input to adjust a color point of the string.

43. A lighting apparatus comprising:
a string comprising a plurality of serially-connected light emitting device sets, each set comprising at least one light emitting device; and
means for variably bypassing current around at least one light emitting device of a set of the plurality of light emitting device sets responsive to a control input.

44. The apparatus of claim 43, wherein the means for variably bypassing current around at least one light emitting device of a set of the plurality of light emitting device sets responsive to a control input comprises a variable resistance circuit.

45. A lighting apparatus comprising:
a string comprising a plurality of serially-connected light emitting device sets, each set comprising at least one light emitting device; and
a fixed bypass circuit configured to bypass a fixed amount of current around at least one light emitting device of at least one selected set of the plurality of light emitting device sets over a range of levels of a total current passing through the string.

46. The apparatus of claim 45, wherein the fixed bypass circuit is configured to bypass at least one light emitting device of a first set of the plurality of light emitting device sets such that a current passing through the first set varies at a different rate than a current through a second set of the plurality of light emitting device sets in response to variation of the total current.

47. The apparatus of claim 46, further comprising a controllable bypass circuit configured to variably bypass current around at least one light emitting device of the second set of light emitting devices responsive to a control input.

48. A lighting apparatus comprising:
a string comprising at least one LED; and
at least one controllable bypass circuit configured to variably bypass current around at the at least one LED via at least one of a diode, a resistor, a transistor and a thermistor.
